(19) United States
(12) Patent Application Publication
(10) Pub. No.: US 2006/0000713 A1
(43) Pub. Date: Jan. 5, 2006

(54) Methods and apparatus for electrodialysis salt splitting

(75) Inventors: Paul Carus III, Peru, IL (US); Duane Mazur, Amherst, NY (US)

Correspondence Address: Howard M. Ellis;SIMPSON & SIMPSON, PLLC, 5555 Main Street, Williamsville, NY, 14221, US

(73) Assignee: Carus Corporation, Peru, IL (US)

(21) Appl. No.: 10/882,601

(22) Filed: Jul. 1, 2004

(51) Int. Cl. B01D 61/46

(52) U.S. Cl. 204/531; 204/634

(57) ABSTRACT

Novel electrochemical cell configurations comprise ion-exchange membranes in combination with at least one porous separator for use in salt splitting methods, including metathesis electrodialysis salt splitting. Methods include production of chemically different oxidizing agents from a first oxidizing agent feed, along with value added salt by-products without adversely affecting permselectivity of the ion-exchange membranes of the cell.

### TECHNICAL FIELD

The present invention relates generally to salt splitting, and more specifically, to improved electrochemical methods and novel electrochemical cells for converting oxidizing agents to other forms of useful oxidants and value added salt by-products.

### BACKGROUND OF THE INVENTION

Oxidizing agents have a broad range of applications in the chemical, environmental, medical and consumer products industries, to name but a few. Permanganates, in particular, are used in a wide variety of applications, including in the oxidation of organic compounds in synthesis reactions, destruction of organics and other species in air and water treatment processes, detoxification and bleaching processes, surface treatments for metals, other substrates, and so on.

Of the permanganate salts, potassium permanganate (KMnO₄) stands out as one of the most widely used. Methods of producing are principally chemical routes.

Potassium permanganate, however, has more limited solubility properties than other permanganate salts. For example, solubilities of >40 percent-by-weight in aqueous solution are achievable with such non-potassium permanganate salts as sodium, calcium and magnesium permanganates. Whereas, aqueous solutions of potassium permanganate are achievable only in a range of 5 or 6 percent-by-weight at room temperature. Hence, the more soluble non-potassium permanganate salts are commercially desirable chemicals, and are often necessary.

Non-potassium permanganate salts are not readily available from native ores. Still, a number of methods have been described for their manufacture from readily available potassium permanganate. The first involves the so called “hexafluorosilicate method” for making sodium permanganate. While this chemical method is effective in the production of sodium permanganate, disadvantages include the generation of large quantities of an insoluble salt by-product, potassium fluorosilicate, which must be disposed of or further treated. The cost of disposal, and the loss of potassium values from the starting permanganate render the process less attractive.

A further method by Kotai and Bannerji disclosed in Synth. React. Inorg. Met.-Org. Chem., 31(3), 491-495 (2001) relates to the preparation of aluminum and barium permanganates from reaction of potassium permanganate and aluminum sulfate in aqueous solution, and further reaction of aluminum permanganate with excess barium hydroxide to form barium permanganate in high purity. The by-products of aluminum sulfate, aluminum hydroxide and barium sulfate are all virtually insoluble to allow isolation of the pure barium permanganate. The barium permanganate thus formed can also be reacted with other soluble sulfate salts, such as ammonium, zinc, cadmium, magnesium and nickel to form the corresponding permanganates in high yield along with insoluble barium sulfate. Disadvantages of this process are the multiple reactions required, the cost of the chemical reagents, and the waste by-products generated, which require suitable treatment and disposal.

Electrochemical processes have been employed in the production of both inorganic and organic compounds. Some have included metathesis electrodialysis methods, and two, three and four compartment salt-splitting electrodialysis processes. Representative patents include: U.S. Pat. No. 5,194,130 disclosing methods for the production of sodium citrate and a strong acid from citric acid and a salt, such as sodium chloride using a three-compartment salt-splitting process; U.S. Pat. No. 4,636,289 discloses a method for converting sodium sulfate from contacting trona ore with sulfuric acid into sodium hydroxide and/or sodium carbonate with regeneration of the acid using a two or three compartment cell, salt-splitting process; and U.S. Pat. No. 4,033,842 discloses a process for making monobasic potassium phosphate and sulfuric acid from potassium sulfate and phosphoric acid from treatment of apatite rock, utilizing a three-compartment electrolysis cell with cationic and anionic selective membranes.

An electrochemical process for the production of oxidizing salts and acids would be desirable, at least from the standpoint of providing a more economic method of making than other methods of synthesis requiring more costly reagents, disposal of unwanted by-products, and so on. Thus, while it could be envisioned that electrodialysis methods, for instance, would provide this and other benefits in the production of oxidizing agents, prior efforts in the field have failed to remedy the substantial technical problem of electrochemical cell membrane instability to oxidizing agents. That is, ion-exchange membranes, particularly the anionic types, certain cationic types and bipolar membranes employed in salt-splitting electrochemical cells for compartment separation and selective transmission of ions of the same polarity to adjacent compartments, can undergo adverse changes. In the presence of such oxidizing agents as potassium permanganate and potassium dichromate membrane performance often deteriorates. Membranes can lose their permselectivity and eventually deteriorate, so they no longer perform as suitable separation barriers between cell compartments.

Accordingly, it would be desirable to have a more economic and reliable electrochemical method and electrochemical cell for the production of oxidizing agents which method can be performed in as little as a single step, while utilizing a single, inexpensive secondary salt feed that yields useful, value added by-products without requiring costly waste treatment and/or disposal.

### SUMMARY OF THE INVENTION

It is therefore one principal object of the invention to provide a novel and inventive salt splitting method primarily for the production of oxidizing agents, and secondarily for the production of useful, value added by-products without costly disposal and/or treatment steps, wherein more readily available oxidizing agents perform as a principal reactant in the process. The method is performed in a novel electrodialysis cell configuration employing permselective ion-exchange membrane(s) in combination with porous separator(s), all without the expected deleterious affects oxidizing agents would otherwise have on the performance and selectivity of such membranes.

Generally, the methods of the invention provide for making oxidizing agents, especially oxidizing agents having enhanced properties, such as improved water solubility over the reactant oxidizing agent, by the steps of:
(i) providing an electrodialysis cell having a plurality of feed and product compartments defined by one or more spaced ion exchange membranes and at least one porous separator, and electrodes comprising a cathode and anode positioned proximate to opposing ends of the cell;
(ii) introducing at least a first oxidizing agent into one of the feed compartments and an electrolyte at the electrodes, and
(iii) imposing a voltage across the electrodes to generate at least a second oxidizing agent which is chemically different than the first oxidizing agent.

For purposes of this invention, the expression “chemically different”, and variations thereof, as appearing in the specification and claims are intended to mean the properties of the new or second oxidizing agent generated by the process, such as solubility are altered from the same property of the first oxidizing agent (reactant), and/or the compositional make-up of the second oxidizing agent is different than the first, e.g., converted to a different salt from the original oxidizing agent, such as converting potassium permanganate to magnesium or calcium permanganate by metathesis electrodialysis, or converting potassium permanganate to an acid, such as permanganic acid by electrodialysis.

“Electrodialysis” or “electrodialysis salt splitting” or variations thereof refer to processes for moving ions across a membrane from one solution to another under the influence of a direct current. Typically, such a process may be carried out in a three compartment electrolytic cell, although cell stacks having four or more compartments may also be employed.

“Metathesis electrodialysis” or “metathesis electro-dialysis salt-splitting”, or variations thereof mean an electrodialysis reaction involving the exchange of ionic species between a plurality of compounds, e.g., AX+BY−>AY+BX.

The methods of the invention may be performed wherein the ion-exchange membrane of the electrodialysis cell comprises at least one cationic permselective membrane positioned adjacent to the cathode, and/or the anode and a porous separator, such as a fluorocarbon microporous separator, is utilized as at least one wall of a cell product compartment. The porous fluorocarbon separator, which is essentially chemically inert and unaffected by strong oxidizing agents, allows a reactive anion specie, such as MnO₄⁻ from the original potassium permanganate feed compartment to be readily transported across to an adjacent product compartment in the direction of the anode, for example, to form a new oxidant by combining with a different cation (e.g., Mg⁺², Ca⁺²) from a salt introduced into a secondary feed compartment of the cell. Alternatively, protons generated by electrolysis of water at the anode may combine with the permanganate anion from salt splitting of the original oxidant to form permanganic acid in the anolyte compartment by positioning a porous separator as a wall of the feed compartment in proximity to the anolyte compartment.

According to methods of the invention embodiments of cell configurations are contemplated wherein cations, such as potassium, split from the potassium permanganate oxidant feed during electrodialysis are employed in forming a useful, value added secondary product, such as KOH from hydroxyl ions generated by electrolysis of the aqueous electrolyte at the cathode.

Further value added by-products may be generated by utilizing anions of the secondary salt feed introduced into the cell in forming the chemically different oxidizing agent. In this regard, cations split from the first oxidant can be combined with anions of the secondary salt feed in a second product compartment by positioning anionic and cationic membranes as adjacent dividers of a secondary product compartment.

Thus, a principal feature of the invention is the discovery of the co-utilization of ion-exchange membranes with porous separators and diaphragms in performing salt-splitting electrodialysis processes involving highly reactive chemical species which would otherwise adversely affect membrane performance. In this regard, porous fluorocarbon separators, such as those formed from PTFE (e.g., Teflon®), for example, are essentially inert to strong oxidants, like potassium permanganate, potassium dichromate, etc., unlike anion exchange membranes, such as the polystyrene-polydivinylbenzene base materials. Porous, chemically inert separators allow the transmission of the negatively charged permanganate or dichromate anion to a product compartment in the direction of the cell anode (+) without adversely affecting separator performance. Simultaneously, a secondary divider also employed in the same cell configuration consisting of a permselective cation exchange membrane selectively allows the transmission of more benign cation species, e.g., Ca⁺², Mg⁺², from a secondary feed compartment to enter the first product compartment in the direction of the cathode (−) to form a more soluble chemically different oxidant, e.g., calcium permanganate without adversely affecting the permselectivity of the membrane.

It is still a further object of the invention to provide a method, wherein the electrodialysis cell comprises a second feed compartment defined by spaced anionic and cationic membranes. The method includes the step of introducing a metal salt into the second feed compartment for salt splitting and selective transmission of anions to an adjacent product compartment to form a value added product with cations derived from the first oxidizing agent.

Hence, methods of the invention contemplate the production of oxidizing agents by the steps of:
(i) introducing an oxidizing agent having a cation and an anion component into a first feed compartment of an electrodialysis cell comprising at least three compartments: the first feed compartment, an anolyte compartment housing an anode and an aqueous electrolyte and a catholyte compartment housing a cathode and an aqueous electrolyte. The first feed compartment is separated from the anolyte compartment by means of at least a porous separator and separated from the catholyte compartment by means of at least a permselective cation exchange membrane, and
(ii) imposing a voltage across the anode and the cathode to generate protons at the anode and hydroxyl groups at the cathode, wherein the anion component of the oxidizing agent is transported across the porous separator from the first feed compartment into the anolyte compartment to form at least an acid of the anion component of the oxidizing agent. The cation component of the oxidizing agent is transported across the permselective cation exchange membrane from the first feed compartment to the catholyte compartment to form at least a base as a value added product.

It is yet a further object of the invention to provide a metathesis electrodialysis salt-splitting process by the steps which comprise:
(i) introducing a first oxidizing agent having a cation and an anion component into a first feed compartment of an electrodialysis cell having a plurality of feed and product compartments separated by a plurality of ion exchange membranes and at least one porous separator proximate to a first product compartment. The electrodialysis cell further comprises an anolyte compartment with at least an anode and an aqueous electrolyte and a catholyte compartment with at least a cathode and an aqueous electrolyte.
(ii) Introducing a metal salt into a second feed compartment of the electrodialysis cell, wherein the metal salt has a different cation than the cation component of the first oxidizing agent, and
(iii) Applying a voltage across the anode and the cathode to generate protons at the anode and hydroxyl ions at the cathode. The anion component of the first oxidizing agent is transported across the at least one porous separator into the first product compartment and the cation of the metal salt in the second feed compartment is transported across a cation exchange membrane into the first product compartment to form a second oxidizing agent. A value added salt by-product is also formed in a separate product compartment from the cation of the first oxidizing agent and the anion of the metal salt from a second feed compartment.

It is still a further object of the invention to provide a novel and inventive electrolytic cell useful in electrodialysis salt-splitting methods and metathesis electrodialysis methods of this invention.

The electrodialysis salt splitting cell comprises at least feed and product compartments defined by one or more spaced ion exchange membranes and at least one porous separator, and electrodes comprising a cathode and anode positioned proximate to opposing ends of the cell. The cell comprises at least one feed compartment, at least one product compartment, and anolyte and catholyte compartments for housing the cathode and the anode. The anolyte compartment is separated from the feed compartment by means of at least a porous separator, and the catholyte compartment is separated from the feed compartment by at least a cation exchange membrane.

A stack of the electrodialysis cell comprises as few as three compartments inclusive of the anolyte and catholyte compartments, as a first embodiment. A cell stack may also comprise four or more compartments exclusive of the anolyte and catholyte compartments, as second or more embodiments. In this aspect of the invention, the electrodialysis cell may comprise at least a central product compartment separated from adjacent feed compartments by means of a porous separator on one side and a cation exchange membrane on the second side for feeding oxidant and metal salt reactants to the cell. Similarly, these embodiments may also have a second product compartment where the desired value-added salt by-product is formed from the cation of the first oxidant and the anion portion of the metal salt feed.

### BRIEF DESCRIPTION OF THE DRAWINGS

For a further understanding of the invention and its characterizing features reference should now be made to the accompanying drawings wherein:

FIG. 1 is a diagrammatic view of a three compartment electrodialysis cell of the invention, inclusive of anolyte and catholyte compartments demonstrating the production of permanganic acid from a single feed of potassium permanganate;

FIG. 2 is a diagrammatic view of a four compartment metathesis electrodialysis cell of the invention illustrating splitting two salts: potassium permanganate and sodium acetate in the production of more soluble sodium permanganate and potassium acetate;

FIG. 3 is also a diagrammatic view of a four compartment metathesis electrodialysis cell demonstrating the splitting of potassium permanganate and sodium hydroxide in the production of sodium permanganate and value added potassium hydroxide;

FIG. 4 is a diagrammatic view of a four compartment metathesis electrodialysis cell illustrating the splitting of sodium chlorate and magnesium acetate in the production of magnesium chlorate and sodium acetate, and

FIG. 5 is a diagrammatic view of a three compartment electrodialysis cell like that of FIG. 1, demonstrating two feed compartments for the production of ammonium permanganate and potassium hydroxide.

### DESCRIPTION OF THE PREFERRED EMBODIMENTS

The methods of the invention enable the production of oxidizing agents electrochemically while avoiding the problems associated with such agents and other reactive species in cells equipped with ion-exchange membranes in metathesis electrodialysis. By employing porous separators in combination with ion-exchange membranes it is now possible to perform electrodialysis salt splitting in the production of more reactive and corrosive chemicals, such as oxidizing agents with the added benefits of increased product purity, controlling and handling by-products generated in the process, pH control, membrane selectivity in the presence of specific oxidizing agents, and so on.

The processes of the invention can now be performed by splitting a first oxidizing agent into cation and anion species and forming a chemically different oxidizing agent, for example, by combining the reactive anion with a different cation simultaneously generated in the same cell by splitting a second salt feed into its constituent cation and anion species. The cation of the salt feed can be combined in a separate product compartment with the anion of the first oxidizing agent to form the “new”, chemically different oxidizing agent of high purity in the same cell. The methods of the invention also provide for the co-production of one or more other value added by-products, such as salts and bases while avoiding required additional steps associated with earlier processes, as will be disclosed in greater detail below.

While details of the invention may be described with reference to a particular oxidizing agent and/or salt feed, such as potassium permanganate and sodium acetate, it is to be understood this is for purposes of convenience only, and it should not be viewed as limiting as to the scope and content of the invention and appended claims. The inventive concepts disclosed herein are applicable to a wide range of substrates, namely the preparation of a broad variety of oxidizing agents with different cations and a wide variation of secondary salt by-products.

In addition to the reactants previously discussed, the electrodialysis salt splitting-cells and methods of making have been illustrated within the framework of specific cell configurations, such as cell stacks comprising three and four-compartments, mainly for purposes of convenience. Notwithstanding, it will be readily apparent among persons of ordinary skill in this art these particular cell configurations are merely representative, and that alternative cell configurations of ion-exchange membranes and porous separators are possible within the inventive concepts of this invention. That is, variations thereof of those specifically mentioned are contemplated in electrodialysis cells having more than three or four compartments, orientations and combinations of anion and cation permselective membranes and porous separators.

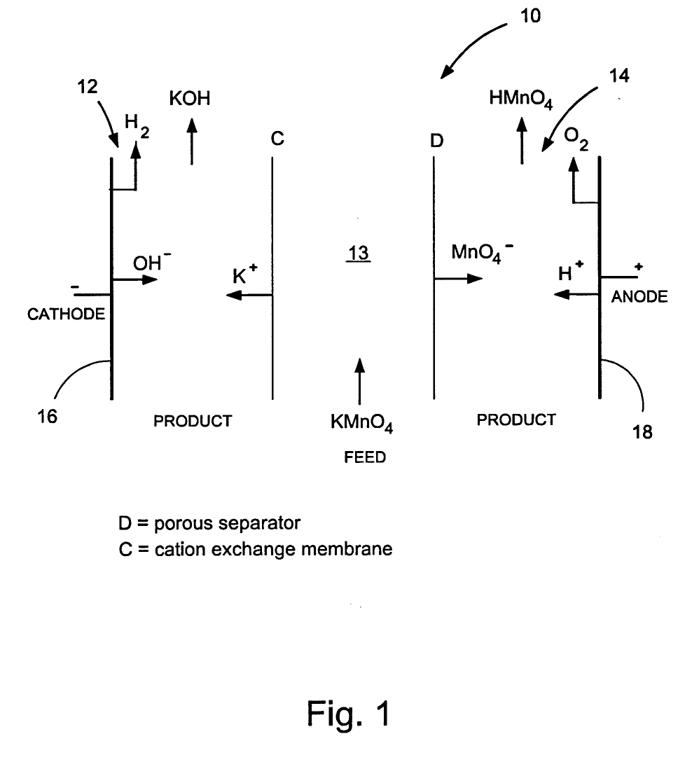

Turning first to FIG. 1, there is illustrated a first embodiment of the invention in the form of a three compartment electrodialysis salt-splitting cell stack 10. The invention contemplates cell stacks having three or more compartments.

In this three compartment cell configuration, numbering of the compartments is inclusive of catholyte and anolyte compartments 12 and 14, respectively, and central feed compartment 13. Anolyte compartments 12 and 14 are also product compartments, i.e., compartments where useful products are formed. In addition to an aqueous electrolyte, compartments 12 and 14 also house cell electrodes consisting of cathode 16 and anode 18.

Generally, anode 18 of the invention should be stable to the electrolysis conditions employed, and compositionally may be comprised of carbons, such as graphite; lead dioxide; noble metals or alloys of platinum, palladium, iridium, gold, ruthenium, to name but a few. Also included in this group are noble metals or alloys deposited onto valve metals, such as titanium, tantalum, etc. Still other materials may be employed, such as nickel and stainless steels with an anolyte, under basic pH conditions. The reaction occurring at the anode 18 will comprise the oxidation of water as illustrated by Equation (I), wherein protons and oxygen are generated:
(Anode) 2H₂O->O₂↑+4H⁺+4e⁻ (I)

Cathode 16, like the anode, should also be stable in the cell environment. Typically, cathodes may be comprised of noble metals and their alloys; nickel, steels, and so on. Generally, the reaction at the cathode involves the reduction of water to produce hydrogen and hydroxyl ions according to equation II below:
(Cathode) 2H₂O+2e⁻->H₂↑+2OH⁻ (II)

The anolyte compartment housing the anode and the catholyte compartment housing the cathode also comprise electrolytes as current carriers for conducting the reactions of this invention. Current carrier employed in electrochemical cells may include, for instance, soluble salts, acids, bases, and so forth. However, in the various embodiments of the invention, including cells having three or more compartments, often the electrolytes will be products generated in the process. For example, in a three compartment cell like that of FIG. 1, permanganic acid in the anolyte compartment and potassium hydroxide in the catholyte compartment will function as suitable current carriers. Similarly, in other embodiments of the invention, such as electrodialysis cells having four or more compartments potassium acetate may perform as the electrolyte. It is to be understood, these are only representative examples of electrolytes, and that other ionizable salts, acids, bases, etc., may be employed, depending on the reaction being performed.

The three compartment electrodialysis cell of FIG. 1 includes a central feed compartment 13 with a cation exchange membrane (C) separating catholyte compartment 12 from feed compartment 13 on the left side, and a porous separator or diaphragm (D) separating anolyte compartment 14 from feed compartment 13.

As illustrated by FIG. 1, cation exchange membrane (C) is intended to include ion-exchange membranes having selective permeability, i.e., permselectivity, allowing the transmission of cations, such as potassium ions from the potassium permanganate in feed compartment 13 to the catholyte/product compartment 12, but not the anions, e.g., MnO₄⁻.

Useful cation exchange membranes may comprise sulfonic acid groups, for example. The cation exchange membrane should be stable and have a low resistance to the cation being transported. Representative examples of useful cation exchange membranes, in addition to the sulfonic acid membranes, include the perfluorinated radiation grafted materials, such as Pall Raipore or Solvay Morgane products and the fully perfluorinated sulfonic acid cation exchange membranes, such as those available from DuPont under the Nafion Trademark, such as the Nafion 300 and 400 series membranes.

The porous separators (D) of the invention denote porous or microporous separators or diaphragms having small pore size structures of micron or submicron size openings, which allow passage of both cations and anions across a potential gradient, but usually minimize the passage of other species by diffusion due to their small pore size. Separators or diaphragms, unlike ion-exchange membranes, are not ionic and typically comprise a single polymeric material, although other non-polymeric materials may be employed, including other essentially chemically inert materials, such as asbestos, which may also be employed. However, they are generally less preferred.

The porous separators (and diaphragms) designated (D) of the invention, unlike the permselective membranes are stable in the presence of strong oxidizing agents and other reactive species, such as strong bases. In addition, they should have low resistance to the ions being transported. Porous separators are commercially available through ordinary channels of commerce. Representative examples of polymeric membranes include perfluorinated materials, such as PTFE membranes available from W. L Gore, under the Goretex® trademark. Others representative materials for polymeric separators include Millipore Durapore PVDF separators, and so on.

As illustrated by FIG. 1, potassium cations are selectively transported across the cation exchange membrane (C) to the catholyte/product compartment 12 where they combine with hydroxyl ions generated by electrolysis of water at the cathode (−) 16 to form a valuable secondary by-product, KOH. Lacking permselectivity, the permanganate anion specie readily migrates simultaneously from the feed compartment 13 across the porous separator (D) into the anolyte/product compartment 14 in the direction of the oppositely charged anode (+) 18 to form a different oxidizing agent, permanganic acid, all without adversely affecting the chemically inert porous separator (D).

The foregoing process leaves behind a depleted feed solution of potassium permanganate. It can, however, be replenished by the addition of potassium permanganate in solid or solution formats to the feed compartments to run this system as a continuous process.

The salt splitting electrolysis process according to the system of FIG. 1 thus provides a valuable solution of permanganic acid, along with a secondary useful co-product, for example, potassium hydroxide, for recovery and sale.

The reactions taking place, according to this embodiment, in the catholyte and anolyte/product compartments are shown below:
(Catholyte compartment) 2H₂O+2K⁺->H₂+2KOH
(Anolyte compartment) H₂O+2MnO₄⁻->½O₂+2HMnO₄

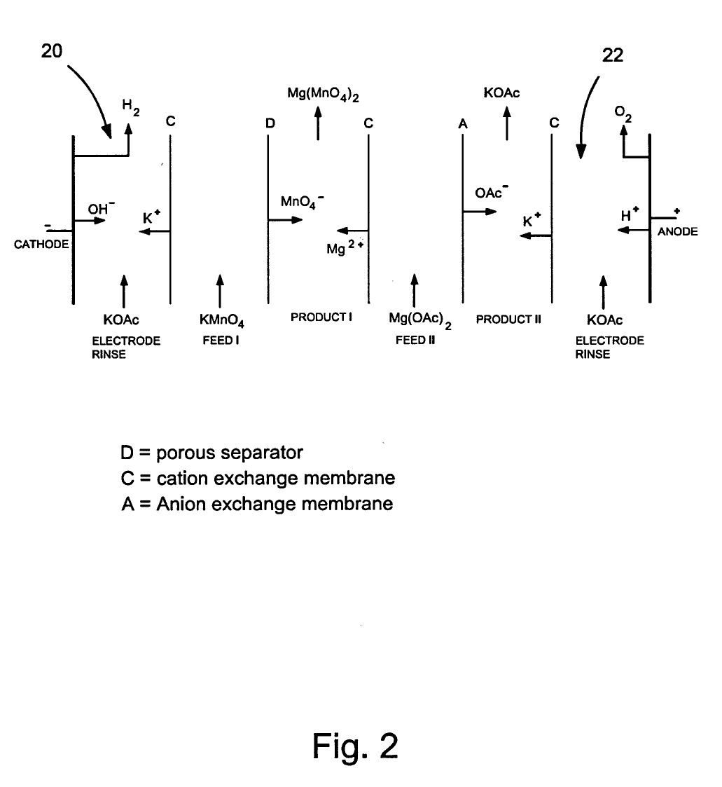

FIG. 2 illustrates a further embodiment of the invention, namely a metathesis electrodialysis salt splitting method performed in a four (4) compartment cell stack (exclusive of catholyte and anolyte compartments 20 and 22). The embodiment of FIG. 2 is representative of the production of a “new”, more soluble oxidizing agent, magnesium permanganate relative to potassium permanganate, and a second valuable salt by-product, potassium acetate, by splitting two salts, potassium permanganate (Feed I) and Magnesium acetate (Feed II).

According to the electrodialysis cell configuration of FIG. 2, multiple (specifically three) cation exchange membranes (C) adjacent to compartments 20 and 22 and the right side of product compartment (I) are employed for selective transmission of potassium and magnesium cations to catholyte compartment 20 and Product compartments (I and II). Also included is an anion exchange membrane (A) to the right side of feed compartment (II) for selective transmission of acetate anions from the salt Feed compartment (II) to Product compartment (II) for the production of the second value added salt by-product, potassium acetate.

Porous separator (D) is positioned on the right side of Feed compartment (I) for transmission of reactive permanganate anions (MnO₄⁻) from feed compartment (I) to the central product compartment (I) in the direction of the anode (+) to form the desired new, more soluble magnesium permanganate oxidizing agent.

The anion exchange membranes as employed herein are defined to indicate membranes which have selective permeability, i.e., permselectivity, by allowing passage of acetate anions (OAc⁻) from a feed compartment (II) to product compartment (II), but not, cations. Anion exchange membranes may be strongly, mildly or weakly basic, and may be comprised of quaternary or tertiary ammonium groups, for example. Anion exchange membranes should be stable and have a low resistance to the anion being transported. In this configuration (FIG. 2), the oxidizing specie (MnO₄⁻) is prevented from entering feed compartment (II) and/or product compartment (II) and contacting the anion exchange membrane due to cation exchange membranes which bound compartments adjacent to the anion exchange membrane.

Representative anion exchange membranes include polystyrene-polydivinyl-benzene polymeric base materials, such as Tokuyama Neosepta AMH or Asahi Glass Selemion AMV, and perfluorinated radiation grafted materials, such as Pall Raipore. Solvay Morgane products may also be used.

As illustrated in FIG. 2, cations migrate towards the cathode (−) through cation exchange membranes where they combine with anions migrating across the anion exchange membrane or microporous separator (D) towards the anode into the desired product compartments to form new products, magnesium permanganate and potassium acetate. This leaves behind depleted feed solutions of magnesium acetate (Feed compartment II) and potassium permanganate (Feed compartment I). These feed streams can be replenished by the addition of magnesium acetate and potassium permanganate in solid or solution format to their respective compartments in order to maintain a continuous process. It will also be apparent the methods, as disclosed herein, can be performed in a batch mode, as well.

Preferably, in the four-compartment configuration as shown by FIG. 2, the anolyte and catholyte streams are tied together outside the cell (not shown). In this way, the only overall change in the electrode rinse streams is the electrolysis of water. It will be understood, however, that potassium acetate is not a necessity for the electrode rinse compartments, but it is preferable to at least employ a potassium salt to avoid contamination of the compartment II product with the introduction of a “foreign” cation. Likewise, potassium acetate may be used for simplicity purposes because it avoids introducing a different anion into the system. Accordingly, the metathesis electrodialysis cell stack will consist of at least one of the above four-compartment units disposed between an anode and cathode, exclusive of the electrode rinse compartments.

The metathesis electrodialysis salt splitting process according to the system of FIG. 2 thus provides a valuable solution of magnesium permanganate, along with a secondary useful co-product, for example, potassium acetate, for recovery and sale. Further physical processing of the magnesium permanganate is also possible, if necessary, in order to remove minor impurities and to provide a suitable commercial product in the desired format.

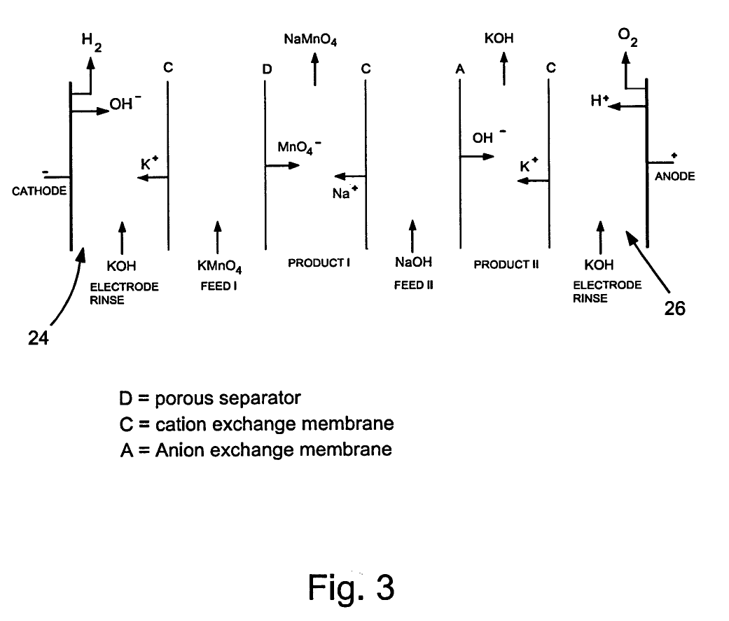

FIG. 3 provides an alternative method for the production of sodium permanganate by metathesis electrodialysis salt splitting employing the same four (4) compartment cell stack as in FIG. 2. Potassium permanganate is introduced into Feed compartment (I) as the first feed, and sodium hydroxide in place of potassium acetate is introduced into Feed Compartment (II) as the second feed to generate more soluble sodium permanganate and a value added base, KOH. Sodium ions from Feed (II) are readily transported across to Product compartment (I) via a cation exchange membrane while permanganate anions are transported across the porous separator (D) into Product compartment (I) to form high purity sodium permanganate. Simultaneously, hydroxyl ions from the caustic soda are transported across the anion exchange membrane (A) to form KOH in Product compartment (II).

Like the embodiment of FIG. 2, part of the KOH product can be combined as a single anode and cathode rinse solution from the anolyte compartment 26 and catholyte compartment 24 outside the cell (not shown).

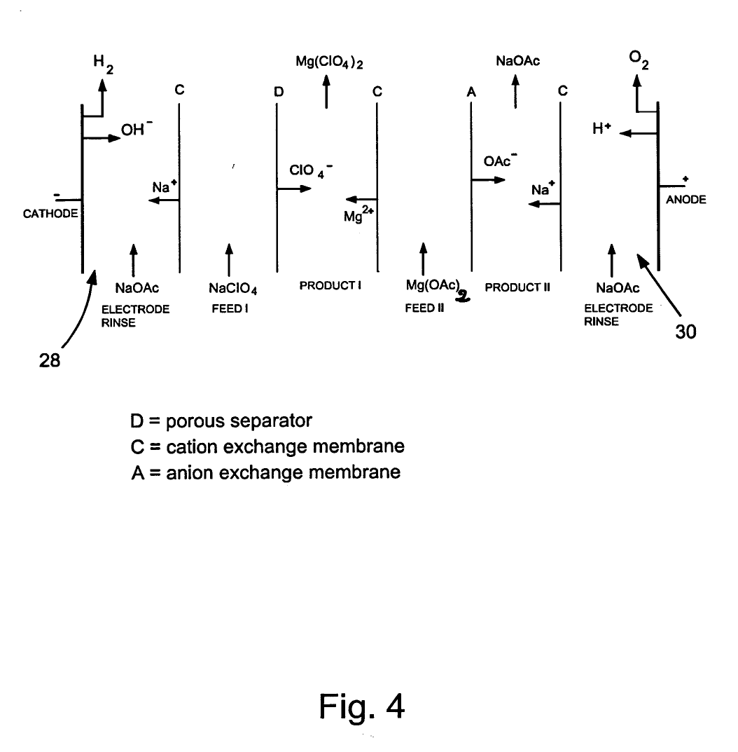

The cell configuration of FIG. 4 is essentially the same as that shown in FIGS. 2 and 3 with the difference of potassium permanganate oxidizing salt feed in Feed compartment (I) being replaced with sodium chlorate, wherein the principal product (Product compartment I) being formed is magnesium chlorate and sodium acetate in Product compartment II. As in the prior embodiments relating to this cell configuration, the anolyte and catholyte from compartments 28 and 30 can be combined outside the cell into a single electrode rinse.

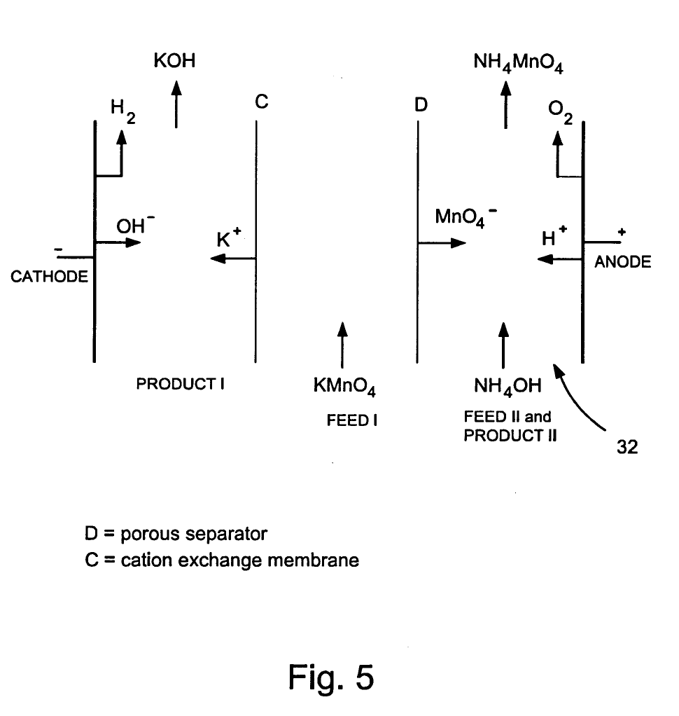

FIG. 5 also illustrates an electrodialysis cell configuration like that of FIG. 1 with the exception that the anolyte compartment 32 performs both as Feed and Product compartment where ammonium hydroxide introduced into the compartment reacts with permanganic acid to form a new product, ammonium permanganate, along with KOH, both valuable products.

The reactions taking place in the cell of FIG. 5 are shown below:
(Cathode) 2H₂O+2K⁺->H₂+2KOH
(Anode) 2NH₄OH+2MnO₄⁻->½O₂+2NH₄MnO₄+2H₂O

Although not specifically illustrated by FIG. 5, this cell configuration possesses flexibility whereby it can be adapted for making other products. For example, acetic acid can also be fed to the catholyte compartment (Product compartment (I)) to make potassium acetate in place of potassium hydroxide. This embodiment also contemplates protons from acetic acid reacting with hydroxyl groups generated at the anode to form water.

The metathesis salt splitting electrodialysis and electrolysis cells of FIGS. 1-5 may be of any design utilized by those skilled in the art, but may also comprise commercially available cells, such as those offered by Eurodia of France (Models EUR 40 or EUR 20) or those available from ElectroCell AB of Sweden (ElectroProd), which provide small intermembrane gaps of between 0.75-2.0 mm to minimize the required impressed cell voltage for a given processing rate for reduced power consumption. The cell may be operated at a unit cell voltage for the four-compartment configuration from about 2.0 volts to 25 volts per stack of membranes, and more preferably, from about 4.0 volts to about 8.0 volts per stack of membranes. The cell may be operated at a unit cell voltage for the three-compartment configuration in a range from about 1.5 volts to about 18 volts per stack of membranes, and more preferably, from about 3.0 volts to about 6.0 volts per stack of membranes.

The operating cell current density should be in the range of 5 to 500 milliamps per square centimeter, and preferably in the range of 25 to 100 milliamps per square centimeter.

Cell operating temperatures should be in a range from about 5 to about 100° C., and more preferably, from about 20 to about 50° C. While higher temperatures than those mentioned above may be suitable, they may cause degradation of some membranes. Due to the nature of the microporous membrane material, differences in solution pressure may cause significant volumes of gross solution to flow into the opposing compartment, which will decrease the efficiency of the process and increase the need to perform further physical purification of the product. Therefore, control of the differential pressure across the microporous separator may be desirable. The operating differential pressure should be from about 0 and 30 inches of water, and more preferably, from between 0 and 10 inches of water. The higher differential pressure can be in either the feed or the product oxidizing agent, but is preferably on the feed oxidizing agent to minimize loss of product efficiency.

The operating concentration ranges of the starting feeds and products can be from about 0% up to the solubility limit of the material. However, in the case of the oxidizing product and feed materials, the concentration values should preferably be maintained within 10% of each other to minimize product loss by diffusion due to a high concentration gradient.

In some instances, impurities in the feed solution and decomposition products may foul the membranes, resulting in a deterioration in cell performance. In some instances, solids, such as manganese dioxide, may precipitate out. In such an event, the cell and membranes can be cleaned in place with acid solutions, including hydrochloric or other mineral acids, or acetic or other organic acids to remove any metal hydroxides. Basic wash solutions may also be employed, preferably after an acid wash. Other wash solutions, such as dilute acidic hydrogen peroxide, or peroxycarboxylic acids may also be employed to solubilize any solid manganese impurities. This “clean in place” procedure may be performed at elevated temperatures of wash solutions, provided the membranes are stable at such temperatures.

The following specific examples demonstrate the various embodiments of the invention, however, it is to be understood they are for illustrative purposes only, and do not purport to be wholly definitive as to conditions and scope.

### EXAMPLE 1

To demonstrate the metathesis electrodialysis salt splitting of potassium permanganate and magnesium acetate to provide magnesium permanganate and potassium acetate in a four-compartment electrodialysis cells the following experiment was conducted:

The following aqueous solutions were prepared: 1) magnesium acetate (800 grams of 35% by weight Mg(OAc)₂.4H₂O, 1.30 moles) as an initial feed; 2) potassium permanganate (1872 grams of 5% by weight KMnO₄, 0.57 moles) as an initial feed; 3) magnesium permanganate (600 grams of 7.5% Mg(MnO₄)₂.5H₂O, equivalent to 5.6% by weight Mg(MnO₄)₂, 0.128 moles) as an initial product; and 4) potassium acetate (1000 grams of 50% by weight KOAc, 5.09 moles) as an initial product. Initial solution pH values were then adjusted to 6.7 for potassium permanganate, 5.9 for magnesium permanganate, 7.3 for potassium acetate and 7.0 for magnesium acetate by addition of aqueous acid.

A metathesis electrodialysis set up was utilized comprised of an ElectroCell MP flow cell with 4 inlet/outlet connections separately connected by means of PTFE and polypropylene piping and valves to 4 individual pumps and 4 individual PTFE tanks to allow continuous batch recirculation through the cell at flow rates up to 1 liter/minute. In addition, the potassium permanganate feed and magnesium permanganate product cell inlet and outlet tubing were connected to a differential pressure controller to be able to maintain a constant cell differential pressure between the two compartments. A Hewlett Packard DC power supply capable of supplying up to 8 amps and 200 volts was connected to the cell. An Electrosynthesis Company model 640 coulometer and shunt was used to record charge passage. The MP flow cell was assembled out of 5 flow frames and 2 inlet/outlet frames made of polyvinylidene fluoride (PVDF), 4 membranes, peroxy-cured EPDM gaskets, and two stainless steel endplates and assembly hardware. The cell configuration was similar to FIG. 2, and was assembled in the order of inlet end frame, gasket, nickel cathode, gasket, catholyte potassium acetate flow frame, gasket, Dupont Nafion® 424 cation exchange membrane, gasket, potassium permanganate flow frame, gasket, Gore PTFE microporous membrane (0.03 micron pore size), gasket, magnesium permanganate flow frame, gasket, Dupont Nafion® 324 bilayer cation exchange membrane, gasket, magnesium acetate flow frame, gasket, Tokuyama Neosepta® AMH anion exchange membrane, gasket, anolyte potassium acetate flow frame, gasket, iridium oxide coated titanium anode, gasket, and outlet end frame, all sandwiched between the stainless steel endplates and bolted to provide adequate sealing. The active electrode area was 0.01 square meter (100 square centimeters). The potassium acetate flow frames were combined at the outlet of the cell to both return to the potassium acetate tank. The solutions were added to the corresponding tanks and were then recirculated through the cell at room temperature. The magnesium permanganate pump was controlled by the differential pressure controller to maintain a maximum positive differential pressure of potassium permanganate across the Gore membrane to between 5-10 inches of water to minimize transport of magnesium permanganate into the potassium permanganate feed. A cell voltage of 13.1 volts was impressed across the stack to maintain a current of 5 amps (current density of 50 milliamps per square centimeter). The system was operated at 5 amps for approximately 2 hours 15 minutes or 40,000 coulombs of charge passed. The cell voltage dropped to 11.5 volts after 15,000 coulombs of charge and slowly rose to 12.6 volts by the end of the experiment. The magnesium permanganate pH slowly rose to 7.19 by the end of the experiment, and the potassium permanganate pH slowly rose to 7.24 at 30,000 coulombs and then to 9.28 at 40,000 coulombs at a point where the concentration was quite low. The potassium acetate and magnesium acetate pH values did not change appreciably during the experiment. Samples were removed at various points in the experiment and analyzed for permanganate, magnesium and potassium levels to define product yields, current efficiencies and total mass balance.

Approximately 1,204 grams of 43.4% potassium acetate solution was recovered (5.31 moles) equivalent to a 53% overall current efficiency for production. Approximately 1067 grams of magnesium permanganate solution was recovered and analyzed for 0.51 moles of permanganate (0.51 moles) which corresponds to a 61% overall current efficiency for production. The level of magnesium analyzed in the potassium acetate product was 340 ppm. The level of potassium analyzed in the spent magnesium acetate feed was 1214 ppm. The level of potassium in the magnesium permanganate product was 719 ppm which was equivalent to 0.02 moles or about 4% of the overall permanganate efficiency. The level of magnesium in the spent potassium permanganate feed was 595 ppm which was equivalent to 0.037 moles corresponding to about 9.0% of the current efficiency that was not attributable to permanganate transport. Analysis of potassium and magnesium mass balance was within experimental error of 5% at all stages of the experiment. Virtually no permanganate was visible in the magnesium acetate feed and the potassium acetate product.

Upon examination of the cell after completion of the experiment, only a minimal amount of manganese dioxide precipitation was observed in the permanganate compartments. This was completely removed by a dilute peroxide/acetic acid wash.

This experiment demonstrated the successful production of magnesium permanganate and potassium acetate from potassium permanganate and magnesium acetate. The current efficiencies for product formation were reasonably good, and product purities were quite high when considering magnesium transport into the potassium acetate and potassium transport into the magnesium permanganate product.

### EXAMPLE 2

To demonstrate the metathesis electrodialysis salt splitting of potassium permanganate and sodium phosphate to provide sodium permanganate and potassium phosphate in a four-compartment electrodialysis cell, the following experiment was conducted:

The following aqueous solutions were prepared: 1) sodium phosphate (641 grams of 10% by weight sodium phosphate, 0.39 moles) as an initial feed; 2) potassium permanganate (1832 grams of 5% by weight KMnO₄, 0.55 moles) as an initial feed; 3) sodium permanganate (615 grams of 5% by weight NaMnO₄, 0.22 moles) as an initial product; and 4) potassium phosphate (1077 grams of 10% K₃PO₄, 0.50 moles) as an initial product. Initial solution pH values were 8.77 for potassium permanganate, adjusted with sodium hydroxide to 12.8 for sodium permanganate, 12.49 for potassium phosphate and 12.35 for sodium phosphate. A metathesis electrodialysis set up was utilized comprised of an ElectroCell MP flow cell with 4 inlet/outlet connections separately connected by means of PTFE and polypropylene piping and valves to 4 individual pumps and 4 individual PTFE tanks to allow continuous batch recirculation through the cell at flow rates up to 1 liters/minute. In addition, the potassium permanganate feed and sodium permanganate product cell inlet and outlet tubing was connected to a differential pressure controller to be able to maintain a constant cell differential pressure between the two compartments. A Hewlett Packard DC power supply capable of supplying up to 8 amps and 200 volts was connected to the cell. An Electrosynthesis Company model 640 coulometer with shunt was used to record charge passage. The MP flow cell was assembled out of 5 flow frames and 2 inlet/outlet frames made of polyvinylidene fluoride (PVDF), 4 membranes, peroxy-cured EPDM gaskets, and two stainless steel endplates and assembly hardware.

The cell configuration was similar to FIG. 2, and was assembled in the order of inlet end frame, gasket, stainless steel type 316 cathode, gasket, catholyte potassium phosphate flow frame, gasket, Dupont Nafion® 117 cation exchange membrane, gasket, potassium permanganate flow frame, gasket, Gore PTFE microporous membrane (0.03 micron pore size), gasket, sodium permanganate flow frame, gasket, Dupont Nafion® 324 bilayer cation exchange membrane, gasket, sodium phosphate flow frame, gasket, Tokuyama Neosepta® AMH anion exchange membrane, gasket, anolyte potassium phosphate flow frame, gasket, iridium oxide coated titanium anode, gasket, and outlet end frame, all sandwiched between the stainless steel endplates and bolted to provide adequate sealing. The active electrode area was 0.01 square meter (100 square centimeters). The potassium phosphate flow frames were combined at the outlet of the cell to both return to the potassium phosphate tank. The solutions were added to the corresponding tanks and were then recirculated through the cell at room temperature. The sodium permanganate pump was controlled by the differential pressure controller to maintain a maximum positive differential pressure of potassium permanganate across the Gore membrane to between 5-10 inches of water to minimize transport of sodium permanganate into the potassium permanganate feed. A cell voltage of 10.4 volts was impressed across the stack to maintain a current of 5 amps (current density of 50 milliamps per square centimeter). The system was operated at 5 amps for approximately 2 hours 25 minutes or 43,000 coulombs of charge passed. The cell voltage slowly rose to 13.4 volts by the end of the experiment. The sodium permanganate pH was at 12.61 at the end of the experiment, and the potassium permanganate pH slowly rose to 10.10 by the end of the experiment. The potassium phosphate pH slightly changed to 12.35 and the sodium phosphate pH dropped slightly to 11.77. Samples were removed at various points in the experiment and analyzed for permanganate to define current efficiencies and total mass balance.

Approximately 627 grams of 9.1% by weight sodium permanganate solution was recovered and was analyzed for 0.41 moles of permanganate which corresponds to a 43% overall current efficiency. Virtually no permanganate was visible in the sodium phosphate feed and the potassium phosphate product. Analysis of permanganate mass balance was within experimental error of 5% at all stages of the experiment

Upon examination of the cell after completion of the experiment, only a minimal amount of manganese dioxide precipitation was observed in the permanganate compartments. This was completely removed by a dilute peroxide/acetic acid wash.

This experiment demonstrated the ability to utilize alternative feeds to obtain alternative permanganate salts and secondary products with reasonably good current efficiency, selectivity and avoidance of fouling.

### EXAMPLE 3

To demonstrate the metathesis electrodialysis salt splitting of sodium chlorate and magnesium acetate to provide magnesium chlorate and sodium acetate in a four-compartment electrodialysis cell, the following experiment is conducted:

The following aqueous solutions are prepared: 1) magnesium acetate (800 grams of 35% by weight Mg(OAc)₂.4H₂O, 1.30 moles) as an initial feed; 2) sodium chlorate (1000 grams of 10% by weight NaClO₃, 0.94 moles) as an initial feed; 3) magnesium chlorate (500 grams of 10% Mg(ClO₃)₂, 0.26 moles) as an initial product; and 4) sodium acetate (1000 grams of 50% by weight NaOAc, 6.09 moles) as an initial product. A metathesis electrodialysis set up is utilized comprising of an ElectroCell MP flow cell with 4 inlet/outlet connections separately connected by means of PTFE and polypropylene piping and valves to 4 individual pumps and 4 individual PTFE tanks to allow continuous batch recirculation through the cell at flow rates up to 1 liters/minute. In addition, the sodium chlorate feed and magnesium chlorate product cell inlet and outlet tubing is connected to a differential pressure controller to be able to maintain a constant cell differential pressure between the two compartments. A Hewlett Packard DC power supply capable of supplying up to 8 amps and 200 volts is connected to the cell. An Electrosynthesis Company model 640 coulometer and shunt is used to record charge passage. The MP flow cell is assembled out of 5 flow frames and 2 inlet/outlet frames made of polyvinylidene fluoride (PVDF), 4 membranes, peroxy-cured EPDM gaskets, and two stainless steel endplates and assembly hardware. The cell configuration is similar to FIG. 2, and is assembled in the order of inlet end frame, gasket, nickel cathode, gasket, catholyte sodium acetate flow frame, gasket, Dupont Nafion® 424 cation exchange membrane, gasket, sodium chlorate flow frame, gasket, Gore PTFE microporous membrane (0.03 micron pore size), gasket, magnesium chlorate flow frame, gasket, Dupont Nafion® 324 bilayer cation exchange membrane, gasket, magnesium acetate flow frame, gasket, Tokuyama Neosepta® AMH anion exchange membrane, gasket, anolyte sodium acetate flow frame, gasket, iridium oxide coated titanium anode, gasket, and outlet end frame, all sandwiched between the stainless steel endplates and bolted to provide adequate sealing. The active electrode area is 0.01 square meter (100 square centimeters). The sodium acetate flow frames are combined at the outlet of the cell to both return to the potassium acetate tank. The solutions are added to the corresponding tanks and were then recirculated through the cell at room temperature. The magnesium chlorate pump is controlled by the differential pressure controller to maintain a maximum positive differential pressure of sodium chlorate across the Gore membrane to between 5-10 inches of water to minimize transport of magnesium chlorate into the sodium chlorate feed. A cell voltage is impressed across the stack to maintain a current of 5 amps (current density of 50 milliamps per square centimeter). The system is operated at 5 amps until approximately 47,250 coulombs of charge is passed (0.50 moles). Samples are removed at various points in the experiment and analyzed for chlorate, magnesium and sodium levels to define product yields, current efficiencies and total mass balance.

This experiment demonstrates the general applicability of the process to different oxidizing species and secondary products.

### EXAMPLE 4

To demonstrate the electrolytic salt splitting of potassium permanganate to provide permanganic acid and potassium hydroxide in a three-compartment electro-dialysis cell, the following experiment was conducted:

The following aqueous solutions were prepared: 1) potassium permanganate (1850 grams of 6% by weight KMnO₄, 0.70 moles) as an initial feed; 2) potassium hydroxide (500 grams of 10% by weight KOH (0.89 moles) as an initial product; and 3) 500 grams of deionized water as the starting product stream for the permanganic acid. A three-compartment electrolysis set up was utilized comprised of an ElectroCell MP flow cell with 3 inlet/outlet connections separately connected by means of PTFE and polypropylene piping and valves to 3 individual pumps and 3 individual PTFE tanks to allow continuous batch recirculation through the cell at flow rates up to 1 liters/minute. In addition, the potassium permanganate feed and permanganic acid product cell inlet and outlet tubing was connected to a differential pressure controller to be able to maintain a constant cell differential pressure between the two compartments. A Hewlett Packard DC power supply capable of supplying up to 8 amps and 200 volts was connected to the cell. An Electrosynthesis Company model 640 coulometer and shunt was used to record charge passage. The MP flow cell was assembled out of 3 flow frames and 2 inlet/outlet frames made of polyvinylidene fluoride (PVDF), 2 membranes, peroxy-cured EPDM gaskets, and two stainless steel endplates and assembly hardware. The cell configuration was similar to FIG. 1, and was assembled in the order of inlet end frame, gasket, nickel cathode, gasket, catholyte potassium hydroxide flow frame, gasket, Dupont Nafion® 117 cation exchange membrane, gasket, potassium permanganate flow frame, gasket, Gore PTFE microporous membrane (0.03 micron pore size), gasket, permanganic acid flow frame, gasket, iridium oxide coated titanium anode, gasket, and outlet end frame, all sandwiched between the stainless steel endplates and bolted to provide adequate sealing. The active electrode area was 0.01 square meter (100 square centimeters). The solutions were added to the corresponding tanks and were then recirculated through the cell at 35° C. temperature via an external heat exchanger connected to the potassium hydroxide stream. The permanganic acid pump was controlled by the differential pressure controller to maintain a maximum positive differential pressure of potassium permanganate across the Gore membrane to between 5-10 inches of water to minimize transport of permanganic acid into the potassium permanganate feed. A cell voltage of 18.1 volts was impressed across the stack to maintain a current of 2 amps (current density of 20 milliamps per square centimeter). The system was operated at 2 amps for approximately 3 hours 30 minutes or 25,200 coulombs of charge passed. The cell voltage dropped to 5.9 volts after 10,000 coulombs of charge and reached 5.0 volts by the end of the experiment. This was due to the increased conductivity of the permanganic acid stream as the concentration increased. Samples were removed at various points in the experiment and analyzed for permanganate, and titrated for acid and base.

Approximately 480 grams of 0.0049% permanganic acid solution was recovered (0.020 moles) equivalent to a 7.7% overall current efficiency for production.

This experiment demonstrated the production of potassium hydroxide and permanganic acid. The permanganic acid production was observed at a lower overall current efficiency, which may be due to the more unstable nature of the permanganic acid product when compared to a permanganate salt, as well as a certain amount of back migration of proton species through the microporous separator material towards the cathode, due to the small size of the proton. This is observed to a much greater extent than with other cationic species.

### EXAMPLE 5

To demonstrate the electrolytic salt splitting of potassium permanganate to provide ammonium permanganate and potassium hydroxide in a three-compartment electrodialysis cell, the following experiment was conducted:

The following aqueous solutions were prepared: 1) potassium permanganate (1865 grams of 6% by weight KMnO₄, 0.68 moles) as an initial feed; 2) potassium hydroxide (600 grams of 10.7% by weight KOH (1.15 moles) as an initial product; and 3) 550 grams of 0.55% potassium permanganate (0.02 moles) as the starting product for the ammonium permanganate stream to provide some initial solution conductivity.

A three-compartment electrolysis set up was utilized comprised of an ElectroCell MP flow cell with 3 inlet/outlet connections separately connected by means of PTFE and polypropylene piping and valves to 3 individual pumps and 3 individual PTFE tanks to allow continuous batch recirculation through the cell at flow rates up to 1 liters/minute. In addition, the potassium permanganate feed and ammonium permanganate product cell inlet and outlet tubing was connected to a differential pressure controller to be able to maintain a constant cell differential pressure between the two compartments. A Hewlett Packard DC power supply capable of supplying up to 8 amps and 200 volts was connected to the cell. An Electrosynthesis Company model 640 coulometer and shunt was used to record charge passage. The MP flow cell was assembled out of 3 flow frames and 2 inlet/outlet frames made of polyvinylidene fluoride (PVDF), 2 membranes, peroxy-cured EPDM gaskets, and two stainless steel endplates and assembly hardware. The cell configuration was similar to FIG. 5, and was assembled in the order of inlet end frame, gasket, nickel cathode, gasket, catholyte potassium hydroxide flow frame, gasket, Dupont Nafion® 424 cation exchange membrane, gasket, potassium permanganate flow frame, gasket, Gore PTFE microporous membrane (0.03 micron pore size), gasket, ammonium permanganate flow frame, gasket, iridium oxide coated titanium anode, gasket, and outlet end frame, all sandwiched between the stainless steel endplates and bolted to provide adequate sealing. The active electrode area was 0.01 square meter (100 square centimeters). The solutions were added to the corresponding tanks and were then recirculated through the cell at 35° C. temperature via an external heat exchanger connected to the potassium hydroxide stream. The permanganic acid pump was controlled by the differential pressure controller to maintain a maximum positive differential pressure of potassium permanganate across the Gore membrane to between 5-10 inches of water to minimize transport of ammonium permanganate into the potassium permanganate feed. A cell voltage of 11.9 volts was impressed across the stack to maintain a current of 5 amps (current density of 50 milliamps per square centimeter). The system was operated at 5 amps for approximately 2 hours 15 minutes or 42,000 coulombs of charge passed. The cell voltage was fairly constant throughout the experiment. At regular intervals throughout the experiment, a total of 34 ml of 29% ammonium hydroxide and 97 ml of 1 molar sodium hydroxide solution were added to the anode compartment to maintain a basic pH.

Samples were removed at various points in the experiment and analyzed for permanganate, and titrated for acid and base.

This experiment demonstrated that alternative neutral permanganate salts can be generated by in-situ neutralization of permanganic acid with an appropriate base, which in this case is ammonium hydroxide. This was expected to increase the stability of the permanganate salt and eliminate the migration of proton species through the microporous separator. In the same manner, an appropriate acid, such as acetic acid could be added in-situ to the potassium hydroxide at the cathode to form potassium acetate.

We claim:

1. A method for making oxidizing agents, which comprises the steps of:
(i) introducing an oxidizing agent having a cation and an anion component into a first feed compartment of an electrodialysis cell comprising at least three compartments: said first feed compartment, an anolyte compartment housing an anode and an aqueous electrolyte and a catholyte compartment housing a cathode and an aqueous electrolyte, said first feed compartment separated from said anolyte compartment by means of at least a porous separator and separated from said catholyte compartment by means of at least a permselective cation exchange membrane, and
(ii) imposing a voltage across said anode and said cathode to generate protons at said anode and hydroxyl groups at said cathode, wherein the anion component of said oxidizing agent is transported across said porous separator from said first feed compartment into said anolyte compartment to form at least an acid of said anion component of said oxidizing agent and the cation component of said oxidizing agent is transported across said permselective cation exchange membrane from said first feed compartment to said catholyte compartment to form at least a base as a value added product.

2. The method according to claim 1, which is an electrodialysis salt-splitting process.

3. The method according to claim 1, wherein said oxidizing agent comprises an anion selected from the group consisting of bromate, chlorate, dichromate, hypochlorite, iodate, perborate, percarbonate, perchlorate periodate, permanganate and peroxodisulfate.

4. The method according to claim 1, wherein the oxidizing agent of the first feed compartment is potassium permanganate, and at least said acid formed is permanganic acid and said value added product comprises potassium hydroxide.

5. The method according to claim 4, including the step of reacting said permanganic acid with a base to form a new permanganate salt.

6. The method according to claim 4, including the step of reacting said potassium hydroxide with an acid to form a new salt.

7. A method for making oxidizing agents, which comprises the steps of:
(i) introducing a first oxidizing agent having a cation and an anion component into a first feed compartment of an electrodialysis cell having a plurality of feed and product compartments separated by at least one ion exchange membrane and at least one porous separator proximate to a first product compartment; said electrodialysis cell further comprising an anolyte compartment with at least an anode and an aqueous electrolyte and a catholyte compartment with at least a cathode and an aqueous electrolyte;
(ii) introducing a metal salt into a second feed compartment of said electrodialysis cell, said metal salt having a different cation than said cation component of said first oxidizing agent, and
(iii) imposing a voltage across said anode and said cathode to generate protons at said anode and hydroxyl ions at said cathode, said anion component of said first oxidizing agent transported across said at least one porous separator into said first product compartment and said cation of said metal salt transported across a cation exchange membrane into said first product compartment to form a second oxidizing agent and a value added salt by-product formed from the cation of said first oxidizing agent and the anion of said metal salt in a second product compartment.

8. The method according to claim 7, which is an metathesis electrodialysis salt-splitting process.

9. The method according to claim 7, wherein said first oxidizing agent comprises an anion selected from the group consisting of bromate, chlorate, dichromate, hypo-chlorite, iodate, perborate, percarbonate, perchlorate periodate, permanganate and peroxodisulfate.

10. The method according to claim 7, wherein said first oxidizing agent is potassium permanganate.

11. The method according to claim 7, wherein the second oxidizing agent comprises at least one member selected from the group consisting of ammonium permanganate, calcium permanganate, magnesium permanganate, sodium permanganate and lithium permanganate.

12. The method according to claim 7, wherein said metal salt comprises at least one anion selected from the group consisting of acetate, propionate, lactate, oxalate, borate, carbonate, chloride, fluoride, bromate, iodate, hydroxide, nitrate, phosphate, dihydrogen phosphate and monohydrogen phosphate.

13. The method according to claim 7, wherein said salt by-product is an alkali metal of an organic acid.

14. The method according to claim 7, wherein said second oxidizing agent is characterized by a greater water solubility relative to said first oxidizing agent.

15. A method for making oxidizing agents, which comprises the steps of:
(i) providing an electrodialysis cell comprising a plurality of feed and product compartments defined by one or more spaced ion exchange membranes and at least one porous separator, and electrodes comprising a cathode and anode positioned proximate to opposing ends of said cell;
(ii) introducing at least a first oxidizing agent into one of said feed compartments and an electrolyte at said electrodes, and
(iii) imposing a voltage across said electrodes to generate at least a second oxidizing agent which is chemically different from said first oxidizing agent.

16. The method according to claim 15, wherein said ion-exchange membrane comprises at least one cationic permselective membrane positioned adjacent to said cathode, and said porous separator defines a wall of at least one product compartment.

17. The method according to claim 16, wherein said second oxidizing agent is an acid or a metal salt.

18. The method according to claim 17, wherein said metal salt of said second oxidizing agent is characterized by a greater water solubility than said first oxidizing agent.

19. The method according to claim 15, wherein said electrodialysis cell comprises a second feed compartment defined by spaced anionic and cationic membranes, said method comprising the step of introducing a metal salt into said second feed compartment for selective transmission of anions to an adjacent product compartment to form a value added product with a cation derived from said first oxidizing agent.

20. The method according to claim 15, wherein said electrodialysis cell is a metathesis electrodialysis salt-splitting cell.

21. The method according to claim 15, wherein the electrodialysis cell is a three or four compartment cell.

22. An electrochemical cell, which comprises at least feed and product compartments defined by one or more spaced ion exchange membranes and at least one porous separator, and electrodes comprising a cathode and anode positioned proximate to opposing ends of said cell.

23. The electrochemical cell according to claim 22, which comprises at least one feed compartment, at least one product compartment, and anolyte and catholyte compartments for housing said cathode and said anode, said anolyte compartment separated from said feed compartment by means of at least a porous separator, and said catholyte compartment separated from said feed compartment by at least a cation exchange membrane.

24. The electrochemical cell according to claim 23, which comprises at least three compartments inclusive of said anolyte and catholyte compartments.

25. The electrochemical cell according to claim 23, which comprises at least four compartments exclusive of said anolyte and catholyte compartments.

26. The electrochemical cell according to claim 25, which comprises at least a central product compartment separated from an adjacent first feed compartment by means of a porous separator, and an adjacent second feed compartment by means of a cationic exchange membrane.
